(19) United States
(12) Patent Application Publication
(10) Pub. No.: US 2014/0260642 A1
(43) Pub. Date: Sep. 18, 2014

(54) ELECTRONIC SYSTEM WITH SURFACE DETECTION MECHANISM AND METHOD OF OPERATION THEREOF

(71) Applicant: Samsung Electronics Co., Ltd., Gyeonggi-Do (KR)

(72) Inventors: Mayank Goel, Seattle, CA (US); James M. A. Begole, Los Altos, CA (US); Stacie Hibino, San Jose, CA (US)

(73) Assignee: Samsung Electronics Co., Ltd., Gyeonggi-Do (KR)

(21) Appl. No.: 13/935,855

(22) Filed: Jul. 5, 2013

Related U.S. Application Data
(60) Provisional application No. 61/788,018, filed on Mar. 15, 2013.

(51) Int. Cl. G01H 11/06

(52) U.S. Cl. CPC G01H 11/06
USPC 73/658

(57) ABSTRACT

An electronic system includes: a vibration broadcast module configured to provide a vibration; a sensor query module, coupled to the vibration broadcast module, with a motion sensor and a sound sensor configured to detect the vibration; and an operation module, coupled to the sensor query module, configured to invoke an operation based on the vibration detected.

### CROSS-REFERENCE TO RELATED APPLICATION(S)

This application claims the benefit of U.S. Provisional Patent Application Ser. No. 61/788,018 filed Mar. 15, 2013, and U.S. Provisional Patent Application Ser. No. 61/676,241 filed Jul. 26, 2012, and the subject matter thereof is incorporated herein by reference thereto.

### TECHNICAL FIELD

An embodiment of the present invention relates generally to an electronic system, and more particularly to a system for networking electronic devices.

### BACKGROUND

Modern communications has brought about a tremendous expansion of wireline and wireless networks. Computer networks, television networks, and telephone networks are experiencing an unprecedented technological expansion, fueled by consumer demand. Wireless and mobile networking technologies have addressed consumer demands including more flexibility and immediacy of information transfer.

Portable devices, such as cellular telephones, have become smaller and lighter while also becoming more capable of performing tasks that far exceed a traditional voice call. An increasing number of portable devices are small computing devices that are capable of running a variety of applications and providing a user with a display on which they may watch video, view web pages, play interactive games, or read text.

Modern consumer and industrial electronics, especially devices such as graphical display systems, televisions, projectors, cellular phones, portable digital assistants, and combination devices, are providing increasing levels of functionality to support modern life including image display. Research and development in the existing technologies can take a myriad of different directions.

This ubiquity of portable devices leads to multiple devices in the same environment. There is value in facilitating communication between all or a subset of these devices. Detecting devices can assist in the facilitation of communication. The devices can be detected by sensors and actuators and acoustic sensors can be leveraged to facilitate touch interactions.

Thus, a need still remains for an electronic system with surface detection mechanism. In view of the ever-increasing commercial competitive pressures, along with growing consumer expectations and the diminishing opportunities for meaningful product differentiation in the marketplace, it is increasingly critical that answers be found to these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### SUMMARY

An embodiment of the present invention provides an electronic system including: a vibration broadcast module configured to provide a vibration; a sensor query module, coupled to the vibration broadcast module, with a motion sensor and a sound sensor configured to detect the vibration; and an operation module, coupled to the sensor query module, configured to invoke an operation based on the vibration detected.

An embodiment of the present invention provides an electronic system including: a vibration broadcast module configured to provide a vibration pattern; a sensor query module, coupled to the vibration broadcast module, configured to use results of a motion sensor and a sound sensor detecting the vibration pattern; and an operation module, coupled to the sensor query module, configured to invoke an operation based on the vibration.

An embodiment of the present invention provides method of operation of an electronic system including: providing a vibration; using a motion sensor and a sound sensor to detect the vibration; and invoking an operation based on the vibration detected.

An embodiment of the present invention provides method of operation of an electronic system including: providing the vibration with a vibration pattern; determining detection results configured to use results of a motion sensor and a sound sensor detecting the vibration pattern to invoke an operation based on the vibration pattern.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is an electronic system with surface detection mechanism in an embodiment of the present invention.

FIG. 2 is an exemplary block diagram of the electronic system.

FIG. 3 is a control flow of the electronic system with surface detection mechanism.

FIG. 4 is an example of a detection pattern of the electronic system.

FIG. 5 is an example of a detection pattern of the electronic system.

FIG. 6 is an example of a detection pattern of the electronic system.

FIG. 7 is a flow chart of a method of operation of an electronic system in a further embodiment of the present invention.

### DETAILED DESCRIPTION

The ubiquity of mobile devices leads to multiple devices in the same environment. There is value in facilitating communication between all or a subset of these devices. One such subset can be devices on the same table (e.g. identifying devices on the same table in a crowded restaurant). It can be difficult to differentiate between devices on the same table or devices near each other using existing state-of-the-art proximity technologies.

The type of surface, such as unpainted concrete, wood, metal, etc., that a device is resting on can be detected. Photo sensors and actuators like light-emitting diodes (LEDs), photoresistors, etc. can detect placement of device, such as in bag, pocket, or on a table, etc. Also acoustic sensors can be leveraged to facilitate touch interactions on a flat surface. Embodiments of the present invention determine whether multiple devices reside on the same specific surface.

The amount of pressure applied on a device can be inferred. The device can be in a user's hand or on a surface. The dampening of vibrations induced by the on-device motor to infer pressure can be measured. It has been found that the dampening of vibrations can be directly proportional to the amount of pressure applied.

Embodiments of the present invention include a system that at least detects networkable electronic devices on the same or common surface using existing on-device sensors and actuators. An option to achieve this uses the concept of hard, flat surfaces including materials' vibration or conduction properties. Devices can emit a pattern of vibrations onto the surface at least through on-device motors. These patterns of vibrations can be detected through inertial sensors such as gyroscope and accelerometer, and microphones. The devices, which are not on the same surface, will not be able to detect these subtle vibration patterns.

A local communication network is established between the devices that are detected on the same flat surface. This network can be used by the devices in a number of scenarios such as sharing of bill in restaurants, sharing documents in a business meeting, interaction for board games, or combination thereof. The relative distances can also be detected between devices to regulate transmission strengths of appropriate radios used for inter-device communication, for example: Bluetooth, WiFi, other communication protocols, or combination thereof.

The following embodiments are described in sufficient detail to enable those skilled in the art to make and use the invention. It is to be understood that other embodiments would be evident based on the present disclosure, and that system, process, or mechanical changes may be made without departing from the scope of the present invention.

Embodiments of the present invention can measure an emitted pattern of vibrations to infer different user behaviors and scenarios for detecting devices present on the same flat surface.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a pressure sensor, an inertial sensor, a microelectromechanical system (MEMS), passive devices, or a combination thereof.

Referring now to FIG. 1, therein is shown an electronic system 100 with surface detection mechanism in an embodiment of the present invention. The electronic system 100 includes a first device 102, such as a client, host, or a server, connected to a second device 106, such as a client, host, or server. The first device 102 can communicate with the second device 106 with a communication path 104, such as a wireless or wired network.

For example, the first device 102 can be of any of a variety of display devices, such as a cellular phone, personal digital assistant, a notebook computer, a liquid crystal display (LCD) system, a light emitting diode (LED) system, or other multi-functional display or entertainment device. The first device 102 can couple, either directly or indirectly, to the communication path 104 to communicate with the second device 106 or can be a stand-alone device.

For illustrative purposes, the electronic system 100 is described with the first device 102 as a display device, although it is understood that the first device 102 can be different types of devices. For example, the first device 102 can also be a device for presenting images or a multi-media presentation. A multi-media presentation can be a presentation including sound, a sequence of streaming images or a video feed, or a combination thereof. As an example, the first device 102 can be a high definition television, a three dimensional television, a computer monitor, a personal digital assistant, a cellular phone, or a multi-media set.

The second device 106 can be any of a variety of centralized or decentralized computing devices, or video transmission devices. For example, the second device 106 can be a multimedia computer, a laptop computer, a desktop computer, a video game console, grid-computing resources, a virtualized computer resource, cloud computing resource, routers, switches, peer-to-peer distributed computing devices, a media playback device, a Digital Video Disk (DVD) player, a three-dimension enabled DVD player, a recording device, such as a camera or video camera, or a combination thereof. In another example, the second device 106 can be a signal receiver for receiving broadcast or live stream signals, such as a television receiver, a cable box, a satellite dish receiver, or a web enabled device.

The second device 106 can be centralized in a single room, distributed across different rooms, distributed across different geographical locations, embedded within a telecommunications network. The second device 106 can couple with the communication path 104 to communicate with the first device 102.

For illustrative purposes, the electronic system 100 is described with the second device 106 as a computing device, although it is understood that the second device 106 can be different types of devices. Also for illustrative purposes, the electronic system 100 is shown with the second device 106 and the first device 102 as end points of the communication path 104, although it is understood that the electronic system 100 can have a different partition between the first device 102, the second device 106, and the communication path 104. For example, the first device 102, the second device 106, or a combination thereof can also function as part of the communication path 104.

The communication path 104 can span and represent a variety of networks. For example, the communication path 104 can include wireless communication, wired communication, optical, ultrasonic, or the combination thereof. Satellite communication, cellular communication, Bluetooth, Infrared Data Association standard (IrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

Referring now to FIG. 2, therein is shown an exemplary block diagram of the electronic system 100. The electronic system 100 can include the first device 102, the communication path 104, and the second device 106. The first device 102 can send information in a first device transmission 208 over the communication path 104 to the second device 106. The second device 106 can send information in a second device transmission 210 over the communication path 104 to the first device 102.

For illustrative purposes, the electronic system 100 is shown with the first device 102 as a client device, although it is understood that the electronic system 100 can have the first device 102 as a different type of device. For example, the first device 102 can be a server having a display interface and a display.

Also for illustrative purposes, the electronic system 100 is shown with the second device 106 as a server, although it is understood that the electronic system 100 can have the second device 106 as a different type of device. For example, the second device 106 can be a client device.

For brevity of description in this embodiment of the present invention, the first device 102 will be described as a client device and the second device 106 will be described as a server device. The present invention is not limited to this selection for the type of devices. The selection is an example of the present invention.

The first device 102 can include a first control unit 212, a first storage unit 214, a first communication unit 216, and a first user interface 218. The first control unit 212 can include a first control interface 222. The first control unit 212 can execute a first software 226 to provide the intelligence of the electronic system 100.

The first control unit 212 can be implemented in a number of different manners. For example, the first control unit 212 can be a processor, an application specific integrated circuit (ASIC), an embedded processor, a microprocessor, a hardware control logic, a hardware finite state machine (FSM), a digital signal processor (DSP), or a combination thereof. The first control interface 222 can be used for communication between the first control unit 212 and other functional units in the first device 102. The first control interface 222 can also be used for communication that is external to the first device 102.

The first control interface 222 can receive information from the other functional units or from external sources, or can transmit information to the other functional units or to external destinations. The external sources and the external destinations refer to sources and destinations external to the first device 102.

The first control interface 222 can be implemented in different ways and can include different implementations depending on which functional units or external units are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage unit 214 can store the first software 226. The first storage unit 214 can also store the relevant information, such as data representing incoming images, data representing previously presented image, sound files, or a combination thereof.

The first storage unit 214 can be a volatile memory, a nonvolatile memory, an internal memory, an external memory, or a combination thereof. For example, the first storage unit 214 can be a nonvolatile storage such as non-volatile random access memory (NVRAM), Flash memory, disk storage, or a volatile storage such as static random access memory (SRAM).

The first storage unit 214 can include a first storage interface 224. The first storage interface 224 can be used for communication between the first storage unit 214 and other functional units in the first device 102. The first storage interface 224 can also be used for communication that is external to the first device 102.

The first storage interface 224 can receive information from the other functional units or from external sources, or can transmit information to the other functional units or to external destinations. The external sources and the external destinations refer to sources and destinations external to the first device 102.

The first storage interface 224 can include different implementations depending on which functional units or external units are being interfaced with the first storage unit 214. The first storage interface 224 can be implemented with technologies and techniques similar to the implementation of the first control interface 222.

The first communication unit 216 can enable external communication to and from the first device 102. For example, the first communication unit 216 can permit the first device 102 to communicate with the second device 106 of FIG. 1, an attachment, such as a peripheral device or a desktop computer, and the communication path 104.

The first communication unit 216 can also function as a communication hub allowing the first device 102 to function as part of the communication path 104 and not limited to be an end point or terminal unit to the communication path 104. The first communication unit 216 can include active and passive components, such as microelectronics or an antenna, for interaction with the communication path 104.

The first communication unit 216 can include a first communication interface 228. The first communication interface 228 can be used for communication between the first communication unit 216 and other functional units in the first device 102. The first communication interface 228 can receive information from the other functional units or can transmit information to the other functional units.

The first communication interface 228 can include different implementations depending on which functional units are being interfaced with the first communication unit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230 as an output device. The first display interface 230 can output to a first display, such as a projector, a video screen, a speaker, or any combination thereof.

The first control unit 212 can operate the first user interface 218 to display information generated by the electronic system 100. The first control unit 212 can also execute the first software 226 for the other functions of the electronic system 100. The first control unit 212 can further execute the first software 226 for interaction with the communication path 104 via the first communication unit 216.

The second device 106 can be used for implementing the present invention in a multiple device embodiment with the first device 102. The second device 106 can provide the additional or higher performance processing power compared to the first device 102. The second device 106 can include a second control unit 234, a second communication unit 236, a second user interface 238, and a second storage unit 246.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can output to a second display 212 of FIG. 2, such as a projector, a video screen, a speaker, or any combination thereof.

The second control unit 234 can execute a second software 242 to provide the intelligence to the second device 106 of the electronic system 100. The second software 242 can operate in conjunction with the first software 226. The second control unit 234 can provide additional performance compared to the first control unit 212.

The second control unit 234 can operate the second user interface 238 to display information. The second control unit 234 can also execute the second software 242 for the other functions of the electronic system 100, including operating the second communication unit 236 to communicate with the first device 102 over the communication path 104.

The second control unit 234 can be implemented in a number of different manners. For example, the second control unit 234 can be a processor, an embedded processor, a microprocessor, hardware control logic, a hardware finite state machine (FSM), a digital signal processor (DSP), or a combination thereof.

The second control unit 234 can include a second control interface 244. The second control interface 244 can be used for communication between the second control unit 234 and other functional units in the second device 106. The second control interface 244 can also be used for communication that is external to the second device 106.

The second control interface 244 can receive information from the other functional units or from external sources, or can transmit information to the other functional units or to external destinations. The external sources and the external destinations refer to sources and destinations external to the second device 106.

The second control interface 244 can be implemented in different ways and can include different implementations depending on which functional units or external units are being interfaced with the second control interface 244. For example, the second control interface 244 can be implemented with a pressure sensor, an inertial sensor, a microelectromechanical system (MEMS), optical circuitry, waveguides, wireless circuitry, wireline circuitry, or a combination thereof.

A second storage unit 246 can store the second software 242. The second storage unit 246 can also store the information, such as data representing incoming images, data representing previously presented image, sound files, or a combination thereof. The second storage unit 246 can be sized to provide the additional storage capacity to supplement the first storage unit 214.

For illustrative purposes, the second storage unit 246 is shown as a single element, although it is understood that the second storage unit 246 can be a distribution of storage elements. Also for illustrative purposes, the electronic system 100 is shown with the second storage unit 246 as a single hierarchy storage system, although it is understood that the electronic system 100 can have the second storage unit 246 in a different configuration. For example, the second storage unit 246 can be formed with different storage technologies forming a memory hierarchal system including different levels of caching, main memory, rotating media, or off-line storage.

The second storage unit 246 can be a volatile memory, a nonvolatile memory, an internal memory, an external memory, or a combination thereof. For example, the second storage unit 246 can be a nonvolatile storage such as non-volatile random access memory (NVRAM), Flash memory, disk storage, or a volatile storage such as static random access memory (SRAM).

The second storage unit 246 can include a second storage interface 248. The second storage interface 248 can be used for communication between the second storage unit 246 and other functional units in the second device 106. The second storage interface 248 can also be used for communication that is external to the second device 106.

The second storage interface 248 can receive information from the other functional units or from external sources, or can transmit information to the other functional units or to external destinations. The external sources and the external destinations refer to sources and destinations external to the second device 106.

The second storage interface 248 can include different implementations depending on which functional units or external units are being interfaced with the second storage unit 246. The second storage interface 248 can be implemented with technologies and techniques similar to the implementation of the second control interface 244.

The second communication unit 236 can enable external communication to and from the second device 106. For example, the second communication unit 236 can permit the second device 106 to communicate with the first device 102 over the communication path 104.

The second communication unit 236 can also function as a communication hub allowing the second device 106 to function as part of the communication path 104 and not limited to be an end point or terminal unit to the communication path 104. The second communication unit 236 can include active and passive components, such as microelectronics or an antenna, for interaction with the communication path 104.

The second communication unit 236 can include a second communication interface 250. The second communication interface 250 can be used for communication between the second communication unit 236 and other functional units in the second device 106. The second communication interface 250 can receive information from the other functional units or can transmit information to the other functional units.

The second communication interface 250 can include different implementations depending on which functional units are being interfaced with the second communication unit 236. The second communication interface 250 can be implemented with technologies and techniques similar to the implementation of the second control interface 244.

The first communication unit 216 can couple with the communication path 104 to send information (e.g. a known test sample) to the second device 106 in the first device transmission 208. The second device 106 can receive information in the second communication unit 236 from the first device transmission 208 of the communication path 104.

The second communication unit 236 can couple with the communication path 104 to send information to the first device 102 in the second device transmission 210. The first device 102 can receive (or retrieve) information in the first communication unit 216 from the second device transmission 210 of the communication path 104.

The electronic system 100 can be executed by the first control unit 212, the second control unit 234, or a combination thereof. For illustrative purposes, the second device 106 is shown with the partition having the second user interface 238, the second storage unit 246, the second control unit 234, and the second communication unit 236, although it is understood that the second device 106 can have a different partition. For example, the second software 242 can be partitioned differently such that some or all of its function can be included in the second control unit 234 and the second communication unit 236. Also, the second device 106 can include other functional units not shown in FIG. 2 for clarity.

The functional units in the first device 102 can work individually and independently of the other functional units. The first device 102 can work individually and independently from the second device 106 and the communication path 104.

The functional units in the second device 106 can work individually and independently of the other functional units. The second device 106 can work individually and independently from the first device 102 and the communication path 104.

For illustrative purposes, the electronic system 100 is described by operation of the first device 102 and the second device 106. It is understood that the first device 102 and the second device 106 can operate any of the modules and functions of the electronic system 100.

Referring now to FIG. 3, therein is shown a control flow of the electronic system 100 with surface detection mechanism. The electronic system 100 can preferably include a position detection module 302, a broadcast notification module 304, a vibration broadcast module 306, a sensor query module 308, an audio sensor module 310, a motion sensor module 312, an on-surface detection module 314, an off-surface detection module 316, and an operation module 318.

One of the first device 102 or the second device 106 such as a server can operate the position detection module 302 such as a GPS detection module configured to receive location information of or locate any of the first device 102 such as portable electronic devices. The position detection module 302 provides a first device 102 of FIG. 1 such as a host or host device and identification of another of the first device 102 such as a client or client device, which are located within a predetermined distance such as in a geographical vicinity.

For example the one of the first device 102 such as a host device leverages GPS data to detect devices in geographical vicinity. Others of the first device 102 such as devices using this service can be connected to the second device 106 such as a central server and report their GPS location to the central server. When the host inquires about the devices nearby, the central server returns the devices in a specific radius of the host, for example 100 meters. While it is impractical for 2 devices to be 100 meters apart from each other and still be on the same surface a large radius can be used as an initial filtering heuristic because GPS data can be inaccurate when the devices are indoors.

The one of the first device 102 such as a host can operate the broadcast notification module 304. The broadcast notification module 304 can provide a vibration pattern at a specified time or a notification of a time for broadcasting the vibration pattern.

For example, the one of the first device 102 such as a host preferably sends to a list of the devices nearby a schedule or an exact time for a broadcast of the vibration pattern such as emitting vibration “beeps”.

The one of the first device 102 such as a host can operate the vibration broadcast module 306. The vibration broadcast module 306 can preferably broadcast or send a vibration pattern from the one of the first device 102 such as a host. The vibration pattern is preferably sent by the host such as a host vibration.

For example, a “daisy chain” detection can be implemented. In some cases, where there are a number of clients or devices on a table, the host can be far from a number of the potential clients or devices, for example on a large conference table. This, often, leads to situations where the clients or devices are unable to reliably detect the vibration patterns broadcast from the host. In such a situation, some clients or devices might be far from the host, but these clients or devices are relatively near some of the other clients or devices. This leads to possibility of a “vibration daisy chain” where identified of the clients become “quasi-host” and broadcast a vibration pattern from the client. This vibration pattern can be identical to the vibration pattern broadcast by the host.

In a further example, some of the one of the first device 102 such as a host lack a vibration motor or the vibration motor is not powerful enough, and hence vibration patterns broadcast or emitted from such devices cannot be detected, recorded, or “picked up” by others of the first device 102 such as clients or proximal devices. If such vibration patterns are not feasible to be detected, recorded, or “picked up”, the host can provide an instruction to a user to physically create a user vibration pattern such as knocking on the surface or table in a pre-defined pattern.

For illustrative purposes, the user can be instructed to knock three times on the table with roughly a one second interval between knocks as this can produces a strong enough vibration that permeates through the surface and can be detected, recorded, or “picked up” by the motion or inertial sensors of the devices on the same surface although it is understood that any pattern may be used. Detection of these user vibration patterns from the knocks can be detected in a manner similar to the vibration patterns broadcast by the host.

The one of the first device 102 such as a host or the second device 106 such as a server can operate the sensor query module 308. The sensor query module 308 provides sending a request or a query for detection of a motion sensor, such as a gyroscope or other motion sensing device, and a sound sensor, such as a microphone or other audio device based on the vibration patterns from the host.

For example, the others of the first device 102 such as clients or devices nearby start sampling with motion or inertial sensors and sound sensors prior to the time set by the host, for example sampling can start one second before the schedule or the exact time. The host preferably uses a pre-defined pattern of pulsing and silence. For illustrative purposes, the vibration pattern used by the host includes a one second vibration followed by a one second silence, followed by another one second vibration although it is understood that any pattern may be used.

The one of the first device 102 such as a host, the another of the first device 102 such as a client, or the second device 106 such as a server can operate the audio sensor module 310. The audio sensor module 310 provides determination of detection results of the audio sensor. The determination of the results of the audio sensor includes detection of a sound pattern correlated to the vibration pattern sent by the host. For illustrative purposes, the host and client sample sound sensors such as microphones at eight kilohertz (8 kHz) although it is understood that any sampling frequency may be used.

The one of the first device 102 such as a host, the another of the first device 102 such as a client, or the second device 106 such as a server can operate the motion sensor module 312. The motion sensor module 312 provides determination of detection results of the motion sensors. The determination of the results of the motion sensor includes detection of a motion pattern correlated to the vibration pattern sent by the host. For illustrative purposes, the host and client sample motion or inertial sensors such as gyroscopes and accelerometers at one hundred hertz (100 Hz) although it is understood that any sampling frequency may be used.

The sensor query module 308, the audio sensor module 310, the motion sensor module 312, or combination thereof can preferably track ambient, background, or local vibration patterns and optionally, wait to broadcast or trigger the vibration pattern, or provide the local vibration patterns to the clients. The waiting to broadcast or the providing the local vibration patterns can address inadvertent vibrations to avoid degradation in performance of surface detection. The providing the local vibration patterns to the clients includes the clients comparing the local vibration patterns with the vibration pattern sent by the host.

The one of the first device 102 such as a host or the second device 106 such as a server can operate the on-surface detection module 314. The on-surface detection module 314 can preferably determine which of the others of the first device 102 such as clients share or on the same or common surface with the host based on the results from the sensor query module 308, the audio sensor module 310, the motion sensor module 312, or combination thereof. The on-surface detection module 314 can also determine a relative distance from each of host or clients to determine the order in which clients perform a certain action.

For example, this relative distance can be used to determine an order for play or “turn” in a multi-user application such as board games. Heuristics can be implemented individually or in combination to infer the relative distance. Firstly, the clients can report timestamps for recording the vibration pattern. A simple, linear comparison of these reported timestamps can determine the relative distance of the host or clients. Secondly, the clients can report an amplitude of a dominant frequency of the audio signal recorded. This amplitude can provide directly proportional distances between the client and the host.

As a further example, a more complex analysis scheme of the reported timestamps for recorded vibrations can be implemented to accurately trilaterate relative locations of the devices on the surface such as a table. The trilateration can preferably identify two-dimensional locations of the devices and implement more complex interactions. In a manner similar to the board game example, devices on opposite sides of a surface from each other can be teamed as a same team.

The one of the first device 102 such as a host or the second device 106 such as a server can operate the off-surface detection module 316. The off-surface detection module 316 can preferably determine which of the others of the first device 102 such as clients do not share or are not on the same or common surface with the host based on the results from the sensor query module 308, the audio sensor module 310, the motion sensor module 312, or combination thereof.

The one of the first device 102 such as a host, the another of the first device 102 such as a client, or the second device 106 such as a server can operate the operation module 318. The operation module 318 can execute or invoke an operation such as a command for the one of the first device 102 such as a host and the another of the first device 102 such as a client based on the results from the sensor query module 308, the audio sensor module 310, the motion sensor module 312, the on-surface detection module 314, or combination thereof. The operation or command of the operation module can include take a photograph, record audio, increase volume, operate other device functions, or combination thereof.

Executing or invoking the operation or command can provide connecting a network for the one of the first device 102 such as a host and the another of the first device 102 such as a client. The network connectivity can include peer to peer (P2P) network communication over any one or combination of protocols supported by the clients and host. For example, the operation module 318 provides connecting a network for the one of the first device 102 such as a host and the another of the first device 102 such as a client that shares or is on the same or common surface with the host based on the results from the audio sensor module 310, the motion sensor module 312, the on-surface detection module 314, or combination thereof.

The first control unit 212 of FIG. 2 or the second control unit 234 of FIG. 2, the first storage unit 214 of FIG. 2 or the second storage unit 248 of FIG. 2, the first communication unit 216 of FIG. 2 or the second communication unit 236 of FIG. 2, a display of the first display interface 230 of FIG. 2 of the first user interface 218 of FIG. 2 or a display of the second display interface 240 of FIG. 2 of the second user interface 238 of FIG. 2, can be configured individually or in combination to operate the position detection module 302, the broadcast notification module 304, the vibration broadcast module 306, the sensor query module 308, the audio sensor module 310, the motion sensor module 312, the on-surface detection module 314, the off-surface detection module 316, and the operation module 318, or combination thereof.

It has been discovered that the position detection module 302, the broadcast notification module 304, the vibration broadcast module 306, the sensor query module 308, the audio sensor module 310, the motion sensor module 312, the on-surface detection module 314, the off-surface detection module 316, and the operation module 318 of the electronic system 100 provides secure network connectivity for the host, clients, and server. The network connectivity is secure based on a physical presence and physical detection of the vibration patterns on the same surface, thus limiting distance and proximity such as to a room or more specifically to a surface or table in the room.

Further, it has been discovered that the modules 304, 306, 308, 310, 312, 314, 316, and 318 of the electronic system 100 provide a well-defined proximity. The proximity includes physical presence and physical detection of the vibration patterns on the same surface.

Yet further, it has been discovered that the modules 304, 306, 308, 310, 312, 314, 316, and 318 of the electronic system 100 provide collaboration between devices or users seated or present in close and well-defined proximity based on physical presence and physical detection of the vibration patterns on the same surface.

Yet further, it has been discovered that that the modules 304, 306, 308, 310, 312, 314, 316, and 318 of the electronic system 100 provide automatic sharing of a check for users sitting on the same table in a restaurant based on physical presence and physical detection of the vibration patterns on the same surface.

Yet further, it has been discovered that that the modules 304, 306, 308, 310, 312, 314, 316, and 318 of the electronic system 100 provide seamless document sharing between business meeting attendees at same conference room table based on physical presence and physical detection of the vibration patterns on the same surface.

Yet further, it has been discovered that that the modules 304, 306, 308, 310, 312, 314, 316, and 318 of the electronic system 100 provide better interaction between board game users based on physical presence and physical detection of the vibration patterns on the same surface.

The electronic system 100 has been described with module functions or order as an example. The electronic system 100 can partition the modules differently or order the modules differently. For example, the audio sensor module 310 on the one of the first device 102 such as a host, the another of the first device 102 such as a client, or the second device 106 such as a server may be implemented after motion sensor module 312 on the another of the first device 102 such as a client, or the second device 106 such as a server.

The modules described in this application can be hardware implementation or hardware accelerators in the first control unit 312 of FIG. 3 or in the second control unit 334 of FIG. 3. The modules can also be hardware implementation or hardware accelerators within the first device 102 or the second device 106 but outside of the first control unit 312 or the second control unit 334, respectively.

The physical transformation from the vibration broadcast module 306 results in the movement in the physical world, such as detection of the vibration patterns in the on-surface detection module 314, the off-surface detection module 316, the operation module 318, or combination thereof. Movement in the physical world results in changes in displays on the host, client, server, or combination thereof based on providing network connectivity resulting from detection of the physical vibration patterns.

Referring now to FIG. 4, therein is shown an example of a detection pattern 400 of the electronic system 100. The detection pattern 400 can preferably include sound data represented by a sound waveform 402. The electronic system 100 with surface detection mechanism preferably captures at least the sound data represented by the sound waveform 402 for one or more of the first device 102 of FIG. 1.

For example, the sound waveform 402 can include a frequency 404 and a time 406. The frequency 404 of the sound waveform 402 can be grouped in a bin such as a low frequency bin of less than one kilohertz (1 kHz). The time 406 of the sound waveform 402 can indicate duration, patterns, correlation to known events, any other time function, or combination thereof. A low frequency group 408 of the frequency 404 with a time correlated to the first device 102 vibrated to provide a vibration pattern can indicate that the first device 102 vibrated to source the vibration pattern is in close proximity to or on the same surface as an another of the first device 102 receiving a waveform 402 indicative of the vibration pattern or correlated to the vibration pattern.

The first control unit 212 of FIG. 2 or the second control unit 234 of FIG. 2, the first storage unit 214 of FIG. 2 or the second storage unit 248 of FIG. 2, a display of the first display interface 230 of FIG. 2 of the first user interface 218 of FIG. 2 or a display of the second display interface 240 of FIG. 2 of the second user interface 238 of FIG. 2, can be configured individually or in combination to any of: vibrate the first device 102 vibrated, receive the waveform 402 by another of the first device 102, group the sound waveform 402, display the sound waveform 402, or combination thereof.

It has been discovered that the first device 102 such as a host or host device vibrated providing a vibration pattern and another of the first device 102 such as a client or a client device recorded a sound waveform 402 correlated to the vibration pattern 402 such as distinct low frequency peaks. The correlation of the vibration pattern and the sound waveform 402 indicates close proximity or “near enough to be on a same surface” of the first device 102 such as the host and the another of the first device 102 such as the client.

Referring now to FIG. 5, therein is shown an example of a detection pattern 500 of the electronic system 100. The detection pattern 500 can preferably include motion data represented by a motion waveform 502. The electronic system 100 with surface detection mechanism preferably captures at least the motion data represented by the motion waveform 402 sourced by one of the first device 102 of FIG. 1.

The motion data represented by the motion waveform 502 can be received by another of the first device 102 such as a client including a gyroscope or other motion sensing apparatus. Correlating the motion waveform 502 received by the another of the first device 102 such as a client to a vibration pattern of the one of the first device 102 such as a host vibrated to source the motion data can indicate close proximity or co-location on a same surface.

For example, the motion waveform 502 can include an angular velocity 504 and a time 506. The angular velocity 504 of the motion waveform 502 can represent motion or movement with higher frequency than vibrations of a busy environment that can include a motor. The motion waveform 502 can include motion or movement data passed through a high pass filter to distinguish and indicate the motion waveform 502 for a vibration pattern sourced by vibrating the first device 102 such as a host.

The first control unit 212 of FIG. 2 or the second control unit 234 of FIG. 2, the first storage unit 214 of FIG. 2 or the second storage unit 248 of FIG. 2, a display of the first display interface 230 of FIG. 2 of the first user interface 218 of FIG. 2 or a display of the second display interface 240 of FIG. 2 of the second user interface 238 of FIG. 2, can be configured individually or in combination to any of: capture the motion data represented by the motion waveform 402 by the another of the first device 102, provide a vibration pattern of the one of the first device 102, correlate the motion waveform 502 to the vibration pattern, display the motion waveform 502, or combination thereof.

It has been discovered that the motion data can be passed through a filter providing the motion waveform 502 indicating that the first device 102 such as a host sourcing a vibration pattern correlated to the motion waveform 502 is in close proximity to or on a same surface as another of the first device 102 such as a client receiving the motion data.

Referring now to FIG. 6, therein is shown an example of a detection pattern 600 of the electronic system 100. The detection pattern 600 can preferably include motion data represented by a motion plot 602. The electronic system 100 with surface detection mechanism preferably captures at least the motion data represented by the motion plot 602 for one or more of the first device 102 of FIG. 1.

The motion plot 602 can include quantized data 604 based on a binary quantization of the motion data represented by the motion waveform 502 of FIG. 5. The quantized data 604 can preferably be computed by the control unit 334 or the control unit 312 of FIG. 3 based on a threshold initially set without vibrating one of the first device 102 such as a host. The motion data sourced by vibrating the one of the first device 102 such as a host and represented by the motion waveform 502 can be received by another of the first device 102 such as a client including a gyroscope or other motion sensing apparatus.

For example, one of the angular velocity 504 detected as larger than the seventy-fifth (75^{th}) percentile of another of the angular velocity 504 detected at rest can be indicated by a bit set to one “1” of the quantized data 604. The angular velocity 504 set to 1 can indicate a potential beginning of a vibration pattern.

The first control unit 212 of FIG. 2 or the second control unit 234 of FIG. 2, the first storage unit 214 of FIG. 2 or the second storage unit 248 of FIG. 2, a display of the first display interface 230 of FIG. 2 of the first user interface 218 of FIG. 2 or a display of the second display interface 240 of FIG. 2 of the second user interface 238 of FIG. 2, can be configured individually or in combination to any of: capture at least the motion data represented by the motion plot 602 by another of the first device 102, vibrate the one of the first device 102 for receipt by another of the first device 102, provide binary quantization of the motion data represented by the motion waveform 502 of FIG. 5, indicate the angular velocity 504 detected as larger than a predetermined value by a bit set to one of the quantized data 604, display the quantized data 604, or combination thereof.

It has been discovered that the quantized data 604 passed through a low pass filter identifies distinct phases of vibration and quietness. The electronic system 100 computes an estimate of durations of these phases. These durations and associated start times are compared with those recorded on the host. If the durations match within a predetermined margin such as half a second, then the one of the first device 102 such as a host and the another of the first device 102 such as a client are given, considered, or inferred to be present on the same table.

Referring now to FIG. 7, therein is shown a flow chart of a method 700 of operation of an electronic system 100 in a further embodiment of the present invention. The method 700 includes: providing a vibration in a block 702; using a motion sensor and a sound sensor to detect the vibration in a block 704; and invoking an operation based on the vibration detected in a block 706.

The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization. Another important aspect of the present invention is that it valuably supports and services the historical trend of reducing costs, simplifying systems, and increasing performance of information technology and consumer electronic products.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations that fall within the scope of the included claims. All matters set forth herein or shown in the accompanying drawings are to be interpreted in an illustrative and non-limiting sense.

What is claimed is:

1. An electronic system comprising:
a vibration broadcast module configured to provide a vibration;
a sensor query module, coupled to the vibration broadcast module, with a motion sensor and a sound sensor configured to detect the vibration; and
an operation module, coupled to the sensor query module, configured to invoke an operation based on the vibration detected.

2. The system as claimed in claim 1 wherein the operation module is configured to invoke the operation to connect a device with a second device.

3. The system as claimed in claim 1 wherein the sensor query module is configured to use the motion sensor and the sound sensor to correlate the vibration.

4. The system as claimed in claim 1 wherein the operation module is configured to invoke the operation based on detection of a motion pattern.

5. The system as claimed in claim 1 wherein the operation module is configured to invoke the operation based on detection of a sound pattern.

6. An electronic system comprising:
a vibration broadcast module configured to provide a vibration pattern;
a sensor query module, coupled to the vibration broadcast module, configured to use results of a motion sensor and a sound sensor detecting the vibration pattern; and
an operation module, coupled to the sensor query module, configured to invoke an operation based on the vibration pattern.

7. The system as claimed in claim 6 wherein the operation module is configured to connect a network to a device based on the vibration pattern.

8. The system as claimed in claim 6 wherein the sensor query module is configured to use results of the motion sensor and the sound sensor of a client device based on the vibration pattern.

9. The system as claimed in claim 6 wherein the operation module is configured to invoke the operation based on the results of the motion sensor correlated to the vibration pattern.

10. The system as claimed in claim 6 wherein the operation module is configured to invoke the operation based on the results of the sound sensor correlated to the vibration pattern.

11. A method of operation of an electronic system comprising:
providing a vibration using a motion sensor and a sound sensor to detect the vibration; and
invoking an operation based on the vibration detected.

12. The method as claimed in claim 11 wherein invoking the operation includes invoking the operation to connect to connect a device with a second device.

13. The method as claimed in claim 11 wherein using the motion sensor and the sound sensor to detect the vibration includes correlating the motion sensor and the sound sensor to the vibration.

14. The method as claimed in claim 11 wherein invoking the operation based on the vibration detected includes invoking the operation based on detection of a sound pattern.

15. The method as claimed in claim 11 wherein invoking the operation based on the vibration detected includes invoking the operation based on detection of a motion pattern.

16. A method of operation of an electronic system comprising:
providing the vibration with a vibration pattern;
determining detection results configured to use results of a motion sensor and a sound sensor detecting the vibration pattern to invoke an operation based on the vibration pattern.

17. The method as claimed in claim 16 wherein determining detection results includes connecting a first device configured to connect to a second device on a same surface.

18. The method as claimed in claim 16 wherein determining detection results includes using the results from the motion sensor and the sound sensor of client device based on the vibration pattern.

19. The method as claimed in claim 16 wherein determining detection results includes connecting a first device configured to connect to a network based on detection results correlated to the vibration pattern.

20. The method as claimed in claim 16 wherein determining detection results includes connecting a first device configured to connect to a network based on detection results correlated to a sound pattern.
